(19) United States
(12) Patent Application Publication
(10) Pub. No.: US 2026/0036712 A1
(43) Pub. Date: Feb. 5, 2026

(54) SMOOTH HYDROPHONE SPECTRUM DIPS AND EXTEND MEASUREMENT FREQUENCY RANGE

(71) Applicant: Halliburton Energy Services, Inc., Houston, TX (US)

(72) Inventors: Chung Chang, Houston, TX (US); Jing Jin, Singapore (SG); Gary Wayne Kainer, Houston, TX (US); Keith Bellman, Houston, TX (US)

(73) Assignee: Halliburton Energy Services, Inc., Houston, TX (US)

(21) Appl. No.: 18/788,518

(22) Filed: Jul. 30, 2024

(51) Int. Cl. G01V 1/44; G01V 1/02; G01V 1/18

(52) U.S. Cl. CPC G01V 1/44; G01V 1/159; G01V 1/186

(57) ABSTRACT

Methods and systems herein may be configured to utilize a downhole tool comprising: a transmitter configured to transmit an acoustic signal into at least part of a conduit string, wherein the transmitter is a first downhole element. In addition, receiver configured to measure an incoming signal from at least part of the conduit string, wherein the receiver is the first downhole element or a second downhole element. Further, disposing a downhole tool into a wellbore, wherein the downhole tool and transmitting an acoustic signal into at least part of a conduit string with the transmitter; and receiving the incoming signal from at least part of a conduit string with the receiver.

### BACKGROUND

For oil and gas exploration and production, a network of wells, installations and other conduits may be established by connecting sections of metal pipe together. For example, a well installation may be completed, in part, by lowering multiple sections of metal pipe (i.e., a conduit string) into a wellbore, and cementing the conduit string in place. In some well installations, multiple conduit strings are employed (e.g., a concentric multi-string arrangement) to allow for different operations related to well completion, production, or enhanced oil recovery (EOR) options.

At the end of a well installations' life, the well installation may be plugged and abandoned. As such, understanding cement bond integrity to a conduit string may be beneficial in determining how to plug the well installation. Traditional sonic tools require the production tubing to be pulled out so that the signal may directly reach casing through borehole fluid. A need in the industry exists in which a CBL may be formed without removing production tubing. Removing production tubing is costly and timely. Thus, through tubing cement evaluation (TTCE) may be performed for cement evaluation without removing production tubing.

Generally, sonic logging may implement lead zirconate titanate (PZT) bender bars to perform TTCE. In sonic logging using PZT bender bar may be utilized as a dipole transmitter, utilizing dipole measurements. Singal processing of dipole measurements may be performed in the frequency domain. Therefore, the time duration of transmitter impulse response is not an engineering concern. However, the many resonances of a traditional PZT bender bar are of concern. To illustrate, each resonance of a traditional PZT bender bar may result in a long duration of transmitting pressure pulse. Each resonance may be too strong, such that it interferes with echoes outside of desirable frequencies which are sensitive to cement conditions. Thus, each resonance mitigates the total operating bandwidth, compromising the capability of examining cement health behind casing.

As such, new engineering challenges arise due to TTCE which requires shorter transmitting pressure pulse to process the echo signals that provide cement integrity information behind casing. A traditional PZT bender bar dipole transmitter has many resonances within a general operating frequency band of 0.5-20 KHz. This results in a long transmitting time pulse that interferes with cement sensitive echoes that can compromise capabilities of examining cement conditions. To overcome this characteristic issue of a PZT bender bar transmitter, a solution for improving the characteristics of a PZT bender bar transmitter may be desirable. Specifically, a solution which results in a smoother spectrum for generating compact pressure pulse that will facilitate TTCE. In addition, a smoother spectrum may also yield a larger bandwidth for hydrophones to receive in the TTCE tools. Further, such a solution must a small volume because of limited space inside a downhole tool.

### BRIEF DESCRIPTION OF THE DRAWINGS

These drawings illustrate certain aspects of some examples of the present disclosure and should not be used to limit or define the disclosure.

FIG. 1 illustrates a system including an acoustic logging tool;

FIG. 2 illustrates an example information handling system;

FIG. 3 illustrates another example information handling system;

FIG. 4 illustrates a standard implementation of bender bar;

FIG. 5 illustrates a cross-sectional view of bender bar;

FIG. 6 illustrates a birds eye view of bender bar;

FIG. 7 illustrates several rubber pads attached to top supporting plate;

FIG. 8 illustrates a cut view of bender bar with passive dampening solution;

FIG. 9 illustrates the incoming amplitude by frequency for bender bar transmitting monopole, dipole, quadrupole, and undecomposed waves;

FIG. 10 illustrates the incoming amplitude by frequency for bender bar transmitting monopole, dipole, quadrupole, and undecomposed waves with dampening solution;

FIG. 11A illustrates a cross section view of hydrophone with an internal dampening solution; and

FIG. 11B illustrates a bird's eye view of hydrophone with an internal dampening solution.

### DETAILED DESCRIPTION

Methods and systems herein may generally relate to passive dampening for a PZT bender bar while transmitting acoustic waves. There are a few guidelines while implementing a passive dampening solution. Methods and systems herein may be adjustable, avoid compromising bender bar acoustic output and occupy smaller footprints due to limited space available inside a slim tool, and be effective in achieving a smoother spectrum. Specifically, the dampening solution may utilize a rubber dampening mechanism. In addition, methods and systems herein may provide passive damping to hydrophones without changing their dimensions. Herein, a smoother spectrum may be defined as a transmitting or receiving spectrum where one or more resonate signals are stretched to encompass a broader range of frequencies. In examples, the amplitude of the resonate frequency may be decreased by a factor of 2 and the range of observable frequencies may be increased by a factor of 10, the procedure may be valid for up to 20% or more of the operation band.

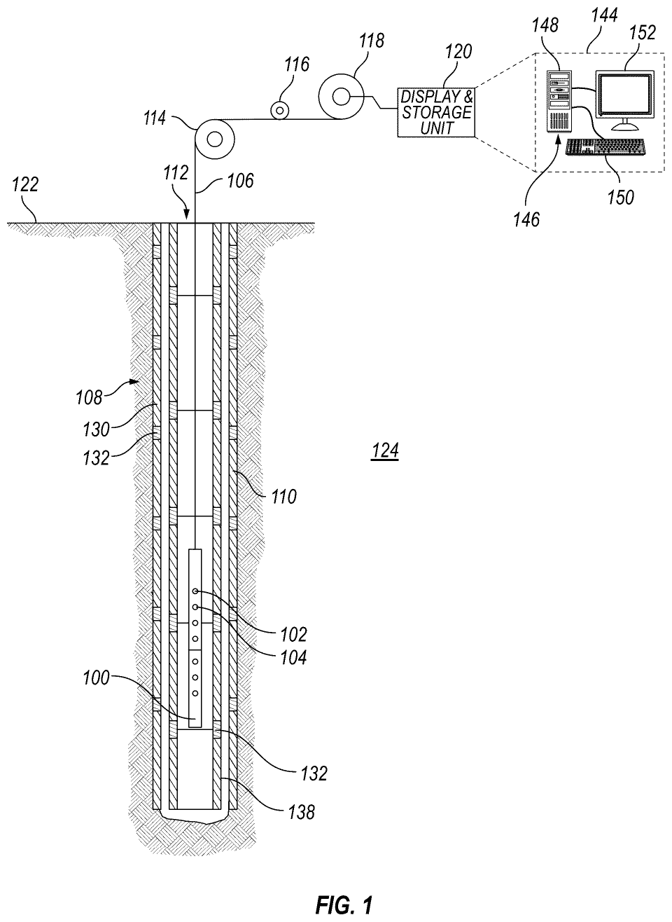

FIG. 1 illustrates an operating environment for an acoustic logging tool 100 as disclosed herein. Acoustic logging tool 100 may comprise a transmitter 102 and/or a receiver 104. Additionally, transmitter 102 and receiver 104 may be configured to rotate in acoustic logging tool 100. In examples, there may be any number of transmitters 102 and/or any number of receivers 104, which may be disposed on acoustic logging tool 100. However, for purposes of this application, transmitters 102 may be a bender bar 400 and receivers 104 may be hydrophones 1100 (to be discussed in detail below). In examples, bender bar 400 may be configured to transmit and receive acoustic signals independent of hydrophones 1100. Further, hydrophones 1100 may also be configured to transmit and receive acoustic signals independent of bender bar 400. Additionally, transmitter 102 and receiver 104 may be configured to rotate in acoustic logging tool 100. Acoustic logging tool 100 may be operatively coupled to a conveyance 106 (e.g., wireline, slickline, coiled tubing, pipe, downhole tractor, and/or the like) which may provide mechanical suspension, as well as electrical connectivity, for acoustic logging tool 100. Conveyance 106 and acoustic logging tool 100 may extend within conduit string 108 to a desired depth within the wellbore 110. In examples, tubing may be concentric in the casing, however in other examples the tubing may not be concentric Conveyance 106, which may include one or more electrical conductors, may exit wellhead 112, may pass around pulley 114, may engage odometer 116, and may be reeled onto winch 118, which may be employed to raise and lower the tool assembly in the wellbore 110. Signals recorded by acoustic logging tool 100 may be stored on memory and then processed by display and storage unit 120 after recovery of acoustic logging tool 100 from wellbore 110. Alternatively, signals recorded by acoustic logging tool 100 may be conducted to display and storage unit 120 by way of conveyance 106. Display and storage unit 120 may process the signals, and the information contained therein may be displayed for an operator to observe and stored for future processing and reference. Alternatively, signals may be processed downhole prior to receipt by display and storage unit 120 or both downhole and at surface 122, for example, by display and storage unit 120. Display and storage unit 120 may also contain an apparatus for supplying control signals and power to acoustic logging tool 100. Typical conduit string 108 may extend from wellhead 112 at or above ground level to a selected depth within a wellbore 110. Conduit string 108 may comprise a plurality of joints 130 or segments of conduit string 108, each joint 130 being connected to the adjacent segments by a collar 132. Additionally, conduit string may include a plurality of tubing and layers.

FIG. 1 also illustrates inner conduit string 108, which may be positioned inside of conduit string 108 extending part of the distance down wellbore 110. Inner conduit string 108 may be production tubing, tubing string, conduit string, or other pipe disposed within conduit string 108. Inner conduit string 108 may comprise concentric pipes. It should be noted that concentric pipes may be connected by collars 132. Acoustic logging tool 100 may be dimensioned so that it may be lowered into the wellbore 110 through inner conduit string 108, thus avoiding the difficulty and expense associated with pulling inner conduit string 108 out of wellbore 110. Herein conduit string 108 may be comprised of inner conduit string 138.

In logging systems, such as, for example, logging systems utilizing the acoustic logging tool 100, a digital telemetry system may be employed, wherein an electrical circuit may be used to both supply power to acoustic logging tool 100 and to transfer data between display and storage unit 120 and acoustic logging tool 100. A DC voltage may be provided to acoustic logging tool 100 by a power supply located above ground level, and data may be coupled to the DC power conductor by a baseband current pulse system. Alternatively, acoustic logging tool 100 may be powered by batteries located within the downhole tool assembly, and/or the data provided by acoustic logging tool 100 may be stored within the downhole tool assembly, rather than transmitted to the surface during logging (corrosion detection).

Acoustic logging tool 100 may be used for excitation of transmitter 102. As illustrated, one or more receiver 104 may be positioned on the acoustic logging tool 100 at selected distances (e.g., axial spacing) away from transmitter 102. The axial spacing of receiver 104 from transmitter 102 may vary, for example, from about 0 inches (0 cm) to about 40 inches (101.6 cm) or more. In some embodiments, at least one receiver 104 may be placed near the transmitter 102 (e.g., within at least 1 inch (2.5 cm) while one or more additional receivers may be spaced from 1 foot (30.5 cm) to about 5 feet (152 cm) or more from the transmitter 102. It should be understood that the configuration of acoustic logging tool 100 shown on FIG. 1 is merely illustrative and other configurations of acoustic logging tool 100 may be used with the present techniques. In addition, acoustic logging tool 100 may include more than one transmitter 102 and more than one receiver 104. For example, an array of receivers 104 may be used. Transmitters 102 may include any suitable acoustic source for generating acoustic waves downhole, including, but not limited to, monopole and multipole sources (e.g., dipole, cross-dipole, quadrupole, hexapole, or higher order multi-pole transmitters). Additionally, one or more transmitters 102 (which may include segmented transmitters) may be combined to excite a mode corresponding to an irregular/arbitrary mode shape. Specific examples of suitable transmitters 102 may include, but are not limited to, piezoelectric elements, bender bars, or other transducers suitable for generating acoustic waves downhole. Receiver 104 may include any suitable acoustic receiver suitable for use downhole, including piezoelectric elements that may convert acoustic waves into an electric signal.

Transmission of acoustic waves by the transmitter 102 and the recordation of signals by receivers 104 may be controlled by display and storage unit 120, which may include an information handling system 144. As illustrated, the information handling system 144 may be a component of the display and storage unit 120. Alternatively, the information handling system 144 may be a component of acoustic logging tool 100. An information handling system 144 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 144 may be a personal computer, a network storage device, or any other suitable device and may vary in size, shape, performance, functionality, and price. Information handling system 144 may include a processing unit 146 (e.g., microprocessor, central processing unit, etc.) that may process EM log data by executing software or instructions obtained from a local non-transitory computer readable media 148 (e.g., optical disks, magnetic disks). The non-transitory computer readable media 148 may store software or instructions of the methods described herein. Non-transitory computer readable media 148 may include any instrumentality or aggregation of instrumentalities that may retain data and/or instructions for a period of time. Non-transitory computer readable media 148 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 144 may also include input device(s) 150 (e.g., keyboard, mouse, touchpad, etc.) and output device(s) 152 (e.g., monitor, printer, etc.). The input device(s) 150 and output device(s) 152 provide a user interface that enables an operator to interact with acoustic logging tool 100 and/or software executed by processing unit 146. For example, information handling system 144 may enable an operator to select analysis options, view collected log data, view analysis returns, and/or perform other tasks.

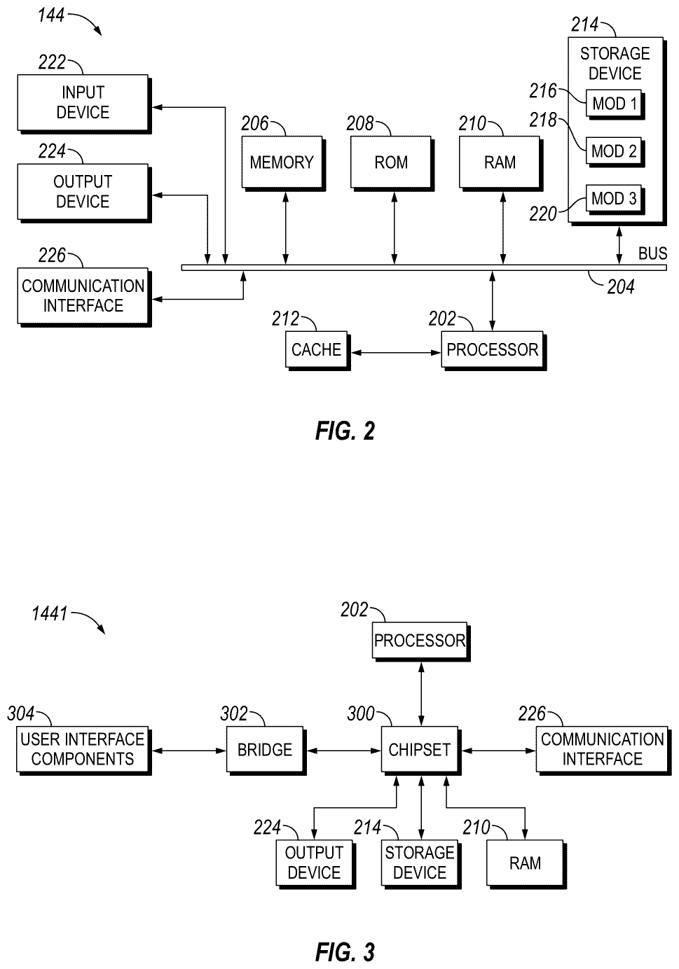

FIG. 2 illustrates an example information handling system 144 which may be employed to perform various steps, methods, and techniques disclosed herein. As illustrated, information handling system 144 includes a processing unit (CPU or processor) 202 and a system bus 204 that couples various system components including system memory 206 such as read only memory (ROM) 208 and random-access memory (RAM) 210 to processor 202. Processors disclosed herein may all be forms of this processor 202. Information handling system 144 may include a cache 212 of high-speed memory connected directly with, in close proximity to, or integrated as part of processor 202. Information handling system 144 copies data from memory 206 and/or storage device 214 to cache 212 for quick access by processor 202. In this way, cache 212 provides a performance boost that avoids processor 202 delays while waiting for data. These and other modules may control or be configured to control processor 202 to perform various operations or actions. Other system memory 206 may be available for use as well. Memory 206 may include multiple different types of memory with different performance characteristics. It may be appreciated that the disclosure may operate on information handling system 144 with more than one processor 202 or on a group or cluster of computing devices networked together to provide greater processing capability. Processor 202 may include any general-purpose processor and a hardware module or software module, such as first module 216, second module 218, and third module 220 stored in storage device 214, configured to control processor 202 as well as a special-purpose processor where software instructions are incorporated into processor 202. Processor 202 may be a self-contained computing system, containing multiple cores or processors, a bus, memory controller, cache, etc. A multi-core processor may be symmetric or asymmetric. Processor 202 may include multiple processors, such as a system having multiple, physically separate processors in different sockets, or a system having multiple processor cores on a single physical chip. Similarly, processor 202 may include multiple distributed processors located in multiple separate computing devices but working together such as via a communications network. Multiple processors or processor cores may share resources such as memory 206 or cache 212 or may operate using independent resources. Processor 202 may include one or more state machines, an application specific integrated circuit (ASIC), or a programmable gate array (PGA) including a field PGA (FPGA).

Each individual component discussed above may be coupled to system bus 204, which may connect each and every individual component to each other. System bus 204 may be any of several types of bus structures including a memory bus or memory controller, a peripheral bus, and a local bus using any of a variety of bus architectures. A basic input/output (BIOS) stored in ROM 208 or the like, may provide the basic routine that helps to transfer information between elements within information handling system 144, such as during start-up. Information handling system 144 further includes storage devices 214 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 214 may include software modules 216, 218, and 220 for controlling processor 202. Information handling system 144 may include other hardware or software modules. Storage device 214 is connected to the system bus 204 by a drive interface. The drives and the associated computer-readable storage devices provide nonvolatile storage of computer-readable instructions, data structures, program modules and other data for information handling system 144. In one aspect, a hardware module that performs a particular function includes the software component stored in a tangible computer-readable storage device in connection with the necessary hardware components, such as processor 202, system bus 204, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 144 is a small, handheld computing device, a desktop computer, or a computer server. When processor 202 executes instructions to perform “operations”, processor 202 may perform the operations directly and/or facilitate, direct, or cooperate with another device or component to perform the operations.

As illustrated, information handling system 144 employs storage device 214, which may be a hard disk or other types of computer-readable storage devices which may store data that are accessible by a computer, such as magnetic cassettes, flash memory cards, digital versatile disks (DVDs), cartridges, random access memories (RAMs) 210, read only memory (ROM) 208, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 144, an input device 222 represents any number of input mechanisms, such as a microphone for speech, a touch-sensitive screen for gesture or graphical input, keyboard, mouse, motion input, speech and so forth. Additionally, input device 222 may take in data from one or more sensors 136, discussed above. An output device 224 may also be one or more of a number of output mechanisms known to those of skill in the art. In some instances, multimodal systems enable a user to provide multiple types of input to communicate with information handling system 144. Communications interface 226 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 202, that is purpose-built to operate as an equivalent to software executing on a general-purpose processor. For example, the functions of one or more processors presented in FIG. 2 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 208 for storing software performing the operations described below, and random-access memory (RAM) 210 for storing returns. Very large-scale integration (VLSI) hardware embodiments, as well as custom VLSI circuitry in combination with a general-purpose DSP circuit, may also be provided.

The logical operations of the various methods, described below, are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. Information handling system 144 may practice all or part of the recited methods, may be a part of the recited systems, and/or may operate according to instructions in the recited tangible computer-readable storage devices. Such logical operations may be implemented as modules configured to control processor 202 to perform particular functions according to the programming of software modules 216, 218, and 220.

In examples, one or more parts of the example information handling system 144, up to and including the entire information handling system 144, may be virtualized. For example, a virtual processor may be a software object that executes according to a particular instruction set, even when a physical processor of the same type as the virtual processor is unavailable. A virtualization layer or a virtual “host” may enable virtualized components of one or more different computing devices or device types by translating virtualized operations to actual operations. Ultimately however, virtualized hardware of every type is implemented or executed by some underlying physical hardware. Thus, a virtualization compute layer may operate on top of a physical compute layer. The virtualization compute layer may include one or more virtual machines, an overlay network, a hypervisor, virtual switching, and any other virtualization application.

FIG. 3 illustrates another example information handling system 144 having a chipset architecture that may be used in executing the described method and generating and displaying a graphical user interface (GUI). Information handling system 144 is an example of computer hardware, software, and firmware that may be used to implement the disclosed technology. Information handling system 144 may include a processor 202, representative of any number of physically and/or logically distinct resources capable of executing software, firmware, and hardware configured to perform identified computations. Processor 202 may communicate with a chipset 300 that may control input to and output from processor 202. In this example, chipset 300 outputs information to output device 224, such as a display, and may read and write information to storage device 214, which may include, for example, magnetic media, and solid-state media. Chipset 300 may also read data from and write data to RAM 210. Bridge 302 for interfacing with a variety of user interface components 304 may be provided for interfacing with chipset 300. Such user interface components 304 may include a keyboard, a microphone, touch detection and processing circuitry, a pointing device, such as a mouse, and so on. In general, inputs to information handling system 144 may come from any of a variety of sources, machine generated and/or human generated.

Chipset 300 may also interface with one or more communication interfaces 226 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 202 analyzing data stored in storage device 214 or RAM 210. Further, information handling system 144 may receive inputs from a user via user interface components 304 and execute appropriate functions, such as browsing functions by interpreting these inputs using processor 202.

In examples, information handling system 144 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

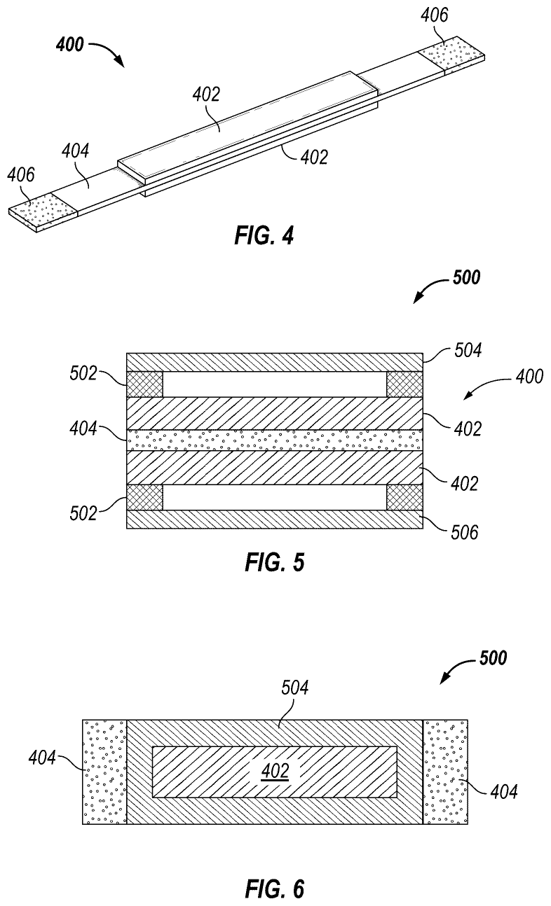

FIG. 4 illustrates a standard implementation of bender bar 400. Traditionally, bender bar 400 in a typical sonic tool may comprise substrate 404, two piezoelectric plates 402, and two fix-ends 406. In examples, the number of substrate 404, piezoelectric plates 402, and fix-ends 406 may vary. In examples, substrate 404 comprise any metal. In examples, metal may comprise steel, titanium, Inconel, aluminum, or the like, or any combination thereof. Further, two piezoelectric plates 402 may recognize and/or react to one or more electric pulses or nearby electric fields. As discussed above, an operating band may be from 0.5-20 KHz. Within this band, there may be one or more resonate frequencies of bender bar 400. Each resonate frequency may observe significant spectrum notches and peaks, preventing receivers 102 or hydrophones 1100 (to be discussed below) from obtaining dipole data from all frequency regions. Resonances contribute to a lasting pressure pulse which interferes with frequencies of cement layer echoes and limits evaluation of cement conditions behind casing. As such, a passive dampening solution may reduce bender bar resonances and smooth its spectrum observed by receivers 102 or hydrophones 1100 to shorten the pressure impulse response in time. As discussed above, smoothing may be transmitting or receiving spectrum where one or more resonating signals are stretched to encompass a broader range of frequencies.

FIG. 5 illustrates a cross-sectional view of bender bar 400 with passive dampening solution 500. The solution utilizes rubber pads 502, top supporting plate 504, and bottom supporting plate 506. Top supporting plate 504 and bottom supporting plate 506 may be hollow to allow for the propagation of piezoelectric plates. Top supporting plate 504 and bottom supporting plate 506 may hold rubber pads 502 along its long edges to the respective piezoelectric plates 402. The rubber pads, held in place between its supporting plate and piezoelectric plate provides vibration dampening. In examples, top supporting plate 504 and bottom supporting plate 506 may be a metal, plastic, or any combination thereof Rubber pads 502 a metal, plastic, or any combination thereof.

Both the top supporting plate 504 and the bottom supporting plate 506 are not anchored as structures that are part of original bender bar 400. Thus, acoustic vibrating energy transmitted to the supporting structures (rubber pads 502, top supporting plate 504, and bottom supporting plate 506) are not going to feedback to bender bar 400 itself. As illustrated, passive dampening solution 500 is implemented along and near the edge of bander bar 400. Applying passive dampening solution 500 to the edges prevents the excitations of twisting motions of a strong resonance for bender bar 400. Dampening solution 500 may be symmetrical and adjustable, as discussed below.

FIG. 6 illustrates a birds eye view of bender bar 400 with passive dampening solution 500. FIG. 6 shows the hollow space of top supporting plate 504 may be illustrated, as evidence of the visible piezoelectric plates 402. Further, the exact opposite perspective of bender bar 400 with passive dampening solution 500, may be symmetrical and show the same figure, except with bottom supporting plate 506 instead of top supporting plate 504.

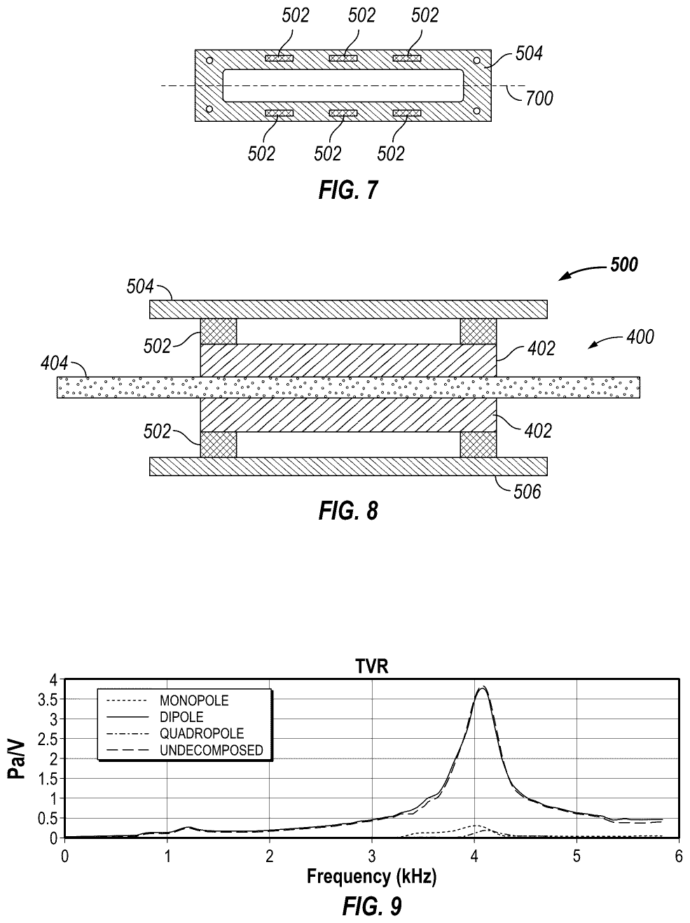

FIG. 7 illustrates several rubber pads 502 attached to top supporting plate 504. Each rubber pad 502 may be adjusted. In examples, the pad's thickness, length, height, width, and the number of rubber of pads 502 may be singular or any plurality. In addition, the pads on the both edge of top supporting plate 504 may be symmetrical or different. Adjusting such factors may be performed to adjust or even in examples, optimize dampening. Further, several rubber pads 502 may be symmetrical across longitudinal axis 700. While FIG. 7 illustrates several rubber pads, there may be only a pair of rubber pads across longitudinal axis 700.

FIG. 8 illustrates a cut view of bender bar 400 with passive dampening solution 500. FIG. 8 shows the lengths of every element for bender bar 400 and passive dampening solution 500 in relation to each other may be illustrated. Further, the exact opposite perspective of bender bar 400 with passive dampening solution 500, may be symmetrical and show the same figure, except with bottom supporting plate 506 instead of top supporting plate 504. The results of passive dampening solution 500 may be illustrated below.

FIG. 9 illustrates the incoming amplitude by frequency for bender bar 400 transmitting monopole, dipole, quadrupole, and undecomposed waves. As illustrated, there is a strong resonance at around 4 KHz. As such, bender bar 400 without any dampening solution will produce a lasting 4 kHz time domain signal beyond 5 ms. A 4 KHz time domain signal will dominate the spectrum, contaminating echoes of cement layer reflections at frequencies above and below 4 KHz. This is undesirable but may be corrected with passive dampening solution 500.

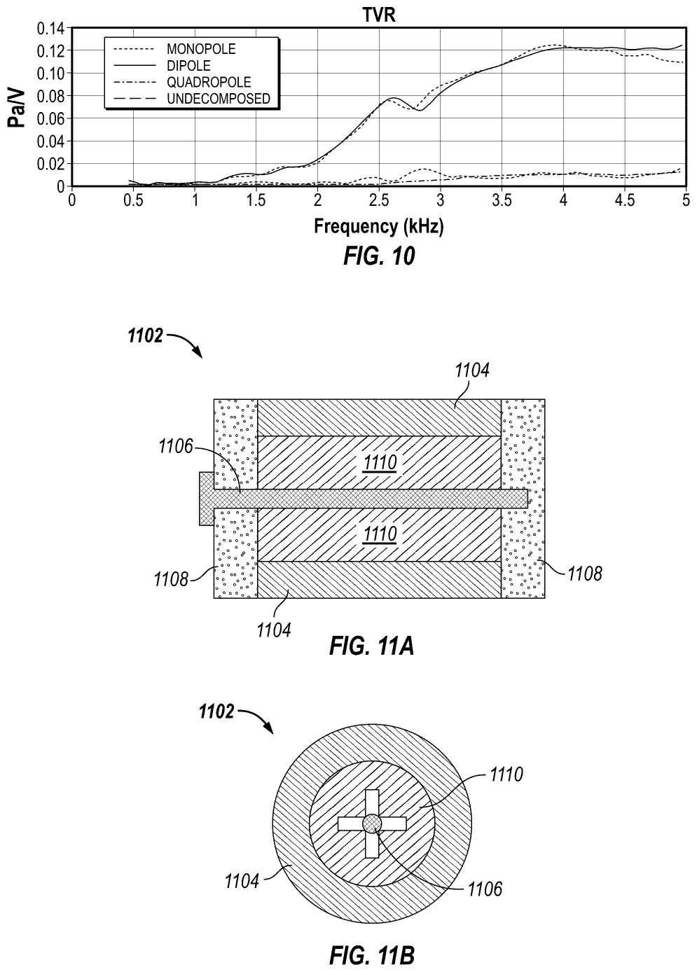

FIG. 10 illustrates the incoming amplitude by frequency for bender bar 400 transmitting monopole, dipole, quadrupole, and undecomposed waves with dampening solution 500. Utilizing dampening solution 500 shows the spectrum improvement without a significant notch or peak. Instead, the peak resonance greatly reduced and spread to a larger bandwidth. Specifically, operation from 0.5 kHz to at least 20 kHz may be possible without contamination of a resonate frequency. As such, a smooth spectrum is produced. Further, time domain impulse signal is more compact in time. Above, a dampening solution has been applied to bender bar 400. In addition, a dampening solution may also be applied for hydrophone 1102.

FIG. 11A illustrates a cross section view of hydrophone 1100 with an internal dampening solution 1102. Internal dampening solution 1102 may comprise PZT cylinder 1104 with a center shaft 1106 and two end caps, installed with rubber dampener 1110. Similar to passive dampening solution 500, internal dampening solution may smooth the spectrum of all resonance modes to a degree that they may not dominate strong spectrum peaks and troughs. There is a potential opportunity of creating a dampening mechanism internally to the cylindrical hydrophone. The cavity inside may be filled with pressure balancing oil and it is important that we still need this pressure balancing function to keep the hydrophone from crashing by the borehole hydrostatic pressure. Therefore, rubber dampener 1110 may be installed in a way, allowing for the balancing oil to flow into those groves and function properly under high hydrostatic pressure. Center shaft 1105 may be supported by two end caps 1108 which result in relative displacements between the vibrating PZT cylinder 1104 and stationary center shaft 1106. In examples, two end caps 1108 may be made from sintered metal allowing fluid to reach PZT cylinder 1104.

Rubber dampener 1110 inside surface may touch center shaft 1106 and its outer surface touch the internal surface of PZT cylinder 1104, creating passive frictional dampening forces. The contact surface area between rubber dampener 1110 and PZT cylinder 1104 and center shaft 1106 may be adjusted. In addition, the durometer of the rubber dampener 1110 as well as the static pressure force created between rubber dampener 1110 and PZT cylinder 1104 may be adjusted to reach an optimized hydrophone response. Further, rubber dampener 1110 may also weaken the strength of the hydrophone resonate mode. FIG. 11B illustrates a bird's eye view of hydrophone 1102 with an internal dampening solution 1102.

The methods and systems described above are an improvement over current technology in the method and systems herein yield a smoother spectrum. Specifically, systems and methods herein employ a variety of adjustable rubber paddings to passively dampen resonate frequencies for both hydrophones and bender bars. As discussed above a general operating frequency band may be from 0.5-20 KHz. However, in examples, this band may be expanded to encompass any frequency of an acoustic wave.

The systems and methods for using a distributed acoustic system in a subsea environment may include any of the various features of the systems and methods disclosed herein, including one or more of the following statements. Additionally, the systems and methods for an acoustic tool in a downhole environment may include any of the various features of the systems and methods disclosed herein, including one or more of the following statements.
Statement 1. A downhole tool comprising: a transmitter configured to transmit an acoustic signal into at least part of a conduit string, wherein the transmitter is a first downhole element; and a receiver configured to measure an incoming signal from at least part of the conduit string, wherein the receiver is the first downhole element or a second downhole element.
Statement 2. The downhole tool of statement 1, wherein the first downhole element is a bender bar and comprises at least a substrate and two piezoelectric plates.
Statement 3. The downhole tool of statement 2, further comprising a dampening solution configured to smooth one or more resonate frequencies of the acoustic signal from the bender bar.
Statement 4. The downhole tool of statement 3, wherein the dampening solution comprises two supporting plates and a plurality of rubber pads.
Statement 5. The downhole tool of statement 4, wherein at least two of the rubber pads from the plurality of rubber pads are positioned between a supporting plate from the two supporting plates and a piezoelectric plate from the two piezoelectric plates.
Statement 6. The downhole tool of statement 5, wherein the at least two rubber pads are positioned along edges of the supporting plate and an edge of the piezoelectric plate.
Statement 7. The downhole tool of statement 6, wherein the at least two rubber pads are symmetrical across a longitudinal axis of the supporting plates.
Statement 8. The downhole tool of statement 4, wherein the two piezoelectric plates are hollow.
Statement 9. The downhole tool of statement 4, wherein a length, height, and width, and a number of the one or more pads is adjustable.
Statement 10. The downhole tool of statement 1, wherein the second downhole element is a hydrophone and comprises an internal dampening solution configured to smooth one or more resonate frequencies of the incoming signal.
Statement 11. The downhole tool of statement 10, wherein the internal dampening solution comprises a lead zirconate titanate (PZT) cylinder with a center shaft.
Statement 12. The downhole tool of statement 11, wherein each end of the center shaft is coupled to an end cap from two end caps, wherein the two end caps comprise sintered metal allowing fluid to reach PZT cylinder.
Statement 13. The downhole tool of statement 12, wherein a rubber dampener is installed around the center shaft to at least partially fill the PZT cylinder.
Statement 14. The downhole tool of statement 13, wherein a durometer of the rubber dampener is adjusted to smooth one or more resonate frequencies of the incoming signal.
Statement 15. The downhole tool of statement 14, wherein a static pressure force created between rubber dampener and the PZT cylinder is adjusted to smooth one or more resonate frequencies of the incoming signal.
Statement 16. A method comprising: disposing a downhole tool into a wellbore, wherein the downhole tool comprises: a transmitter configured to transmit an acoustic signal into at least part of a conduit string; and a receiver configured to measure an incoming signal from at least part of the conduit string; transmitting an acoustic signal into at least part of a conduit string with the transmitter; and receiving the incoming signal from at least part of a conduit string with the receiver.
Statement 17. The method of statement 16, further comprising smoothing one or more resonate frequencies of the acoustic signal from the transmitter with a dampening solution.
Statement 18. The method of statement 17, wherein the dampening solution comprises two supporting plates, one or more rubber pads.
Statement 19. The method of statement 16, further comprising smoothing one or more resonate frequencies of the incoming signal an internal dampening solution.
Statement 20. The method of statement 19, wherein the internal dampening solution comprises a lead zirconate titanate (PZT) cylinder with a center shaft, wherein each end of the center shaft is coupled to an end cap.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

1. A downhole tool comprising:
a transmitter configured to transmit an acoustic signal into at least part of a conduit string, wherein the transmitter is a first downhole element; and
a receiver configured to measure an incoming signal from at least part of the conduit string, wherein the receiver is the first downhole element or a second downhole element.

2. The downhole tool of claim 1, wherein the first downhole element is a bender bar and comprises at least a substrate and two piezoelectric plates.

3. The downhole tool of claim 2, further comprising a dampening solution configured to smooth one or more resonate frequencies of the acoustic signal from the bender bar.

4. The downhole tool of claim 3, wherein the dampening solution comprises two supporting plates and a plurality of rubber pads.

5. The downhole tool of claim 4, wherein at least two of the rubber pads from the plurality of rubber pads are positioned between a supporting plate from the two supporting plates and a piezoelectric plate from the two piezoelectric plates.

6. The downhole tool of claim 5, wherein the at least two rubber pads are positioned along edges of the supporting plate and an edge of the piezoelectric plate.

7. The downhole tool of claim 6, wherein the at least two rubber pads are symmetrical across a longitudinal axis of the supporting plates.

8. The downhole tool of claim 4, wherein the two piezoelectric plates are hollow.

9. The downhole tool of claim 4, wherein a length, height, and width, and a number of the one or more pads is adjustable.

10. The downhole tool of claim 1, wherein the second downhole element is a hydrophone and comprises an internal dampening solution configured to smooth one or more resonate frequencies of the incoming signal.

11. The downhole tool of claim 10, wherein the internal dampening solution comprises a lead zirconate titanate (PZT) cylinder with a center shaft.

12. The downhole tool of claim 11, wherein each end of the center shaft is coupled to an end cap from two end caps, wherein the two end caps comprise sintered metal allowing fluid to reach PZT cylinder.

13. The downhole tool of claim 12, wherein a rubber dampener is installed around the center shaft to at least partially fill the PZT cylinder.

14. The downhole tool of claim 13, wherein a durometer of the rubber dampener is adjusted to smooth one or more resonate frequencies of the incoming signal.

15. The downhole tool of claim 14, wherein a static pressure force created between rubber dampener and the PZT cylinder is adjusted to smooth one or more resonate frequencies of the incoming signal.

16. A method comprising:
disposing a downhole tool into a wellbore, wherein the downhole tool comprises:
a transmitter configured to transmit an acoustic signal into at least part of a conduit string; and
a receiver configured to measure an incoming signal from at least part of the conduit string;
transmitting an acoustic signal into at least part of a conduit string with the transmitter; and
receiving the incoming signal from at least part of a conduit string with the receiver.

17. The method of claim 16, further comprising smoothing one or more resonate frequencies of the acoustic signal from the transmitter with a dampening solution.

18. The method of claim 17, wherein the dampening solution comprises two supporting plates, one or more rubber pads.

19. The method of claim 16, further comprising smoothing one or more resonate frequencies of the incoming signal an internal dampening solution.

20. The method of claim 19, wherein the internal dampening solution comprises a lead zirconate titanate (PZT) cylinder with a center shaft, wherein each end of the center shaft is coupled to an end cap.
